(19) United States
(12) Patent Application Publication
(10) Pub. No.: US 2019/0130268 A1
(43) Pub. Date: May 2, 2019

(54) TENSOR RADIX POINT CALCULATION IN A NEURAL NETWORK

(71) Applicant: Wave Computing, Inc., Campbell, CA (US)

(72) Inventors: Kenneth Shiring, San Jose, CA (US); Stephen Curtis Johnson, Morgan Hill, CA (US)

(21) Appl. No.: 16/174,786

(22) Filed: Oct. 30, 2018

Related U.S. Application Data
(63) Continuation-in-part of application No. 16/170,268, filed on Oct. 25, 2018.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06N 3/08; G06N 3/04

(52) U.S. Cl. CPC G06N 3/08; G06N 3/04

(57) ABSTRACT

Techniques are disclosed for tensor radix point calculation in a neural network. A first tensor is obtained. A first set of weights is generated for the first tensor. An operation is evaluated to be performed by a layer within a deep neural network on the first tensor using the first set of weights. A set of output radix points is determined for the layer within the deep neural network based on the first tensor and the operation. An output tensor is calculated for the layer within the deep neural network using the set of output radix points, the first tensor, and the first set of weights. The operation is restarted, when the layer reports a hardware overflow, using an updated set of output radix points. The determining is further based on a radix point for the first tensor. The determining is further based on metadata for the first tensor.

### RELATED APPLICATIONS

This application claims the benefit of U.S. provisional patent applications “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to computational manipulation and more particularly to tensor radix point calculation in a neural network.

### BACKGROUND

The trend of business, researchers, and governments to collect data has resulted in vast and ever-expanding datasets. The datasets are commonly referred to as “big data”. These collectors and other entities are interested in processing these vast datasets and performing a wide range of tasks using the data. The tasks can include learning, marketing, and predicting, among many others. Conventional architectures, processors, and techniques cannot process and analyze the “big data” datasets for the simple reason that the analysis overwhelms the computational capabilities of the conventional systems and approaches. In addition to data access, the analysis, capture, maintenance, storage, transmission, visualization, and so on, can quickly overwhelm the capabilities of the traditional systems. With no ability to process the data, there would be little or no value to the data. Instead, new processing algorithms, heuristics, techniques, and so on are required. Those who possess the datasets or have access to the datasets are eager to perform a variety of analysis tasks on the data contained in the datasets. Common analysis purposes include: business analysis; complex science and engineering simulations; crime detection and prevention; disease detection, tracking, and control; and meteorology; to name only a few. Advanced data analysis techniques such as predictive analytics are interesting because they can be used for extracting value from the datasets for business and other purposes. Other uses for the datasets include machine learning and deep learning.

Neural networks, commonly called artificial neural networks (ANN), mimic biological neural networks. These computational systems “learn” based on developing improved system performance while executing a given task. The task can include image recognition, speech recognition, and other computationally intensive applications. This “learning”, called machine learning, is based on the premise that computers can be trained to perform a task without being specifically programmed to do so. The training builds algorithms to learn using a known dataset (supervised learning). The algorithms can then be used to make predictions about the current and future datasets. The advantage of machine learning is that the algorithms are based on models. The algorithms can adapt and improve over time based on past experience with data such as prediction success rates and error rates. A model is constructed from a set of sample data with known characteristics. The model is trained using the known data to make desired predictions and decisions. Once the model has been trained, the model is applied to other datasets. The model can be updated over time based on the success rate of the model to make correct predictions using the data. Applications of such machine learned models include: network and system intrusion detection, optical character recognition (OCR), email filtering for spam detection, computer vision (CV), and so on. The success of the model is limited by the quality of the training data. Analysis of the training data often requires human intervention, so such analysis is both expensive and at risk of human error.

Deep neural networks (DNN) are a form of artificial neural networks (ANN). Like artificial neural networks, the deep neural networks are based on layers. For the deep neural networks, there can be multiple hidden layers between the input layer and the output layer. DNNs are well suited to modeling complex, non-linear relationships. A DNN can be used to generate a compositional model. A compositional model can support automatic formulation of models using explicit representation for modeling assumptions. The compositional model can be expressed as a layered composition of primitive data types. The additional layers of the DNN can support formulation of features from lower layers of the composition. The result can be modeling the complexities of data using fewer computational resources. Thus, machine learning in the form of deep neural networks can enable greater computational power than traditional computational architectures.

### SUMMARY

Neural networks can be used to process vast quantities of unstructured data. The neural networks can manipulate tensors, where the tensors can represent the data including the unstructured data. Neural networks are finding many data processing applications in diverse fields such as machine learning, including deep learning, artificial intelligence, business and research applications such as trend analysis, and so on. Von Neumann and other traditional control flow computational architectures are not well suited to highly data-intensive processing requirements. Although designers and architects continue to construct faster processors, improved custom integrated circuits or chips, more capable application specific integrated circuits (ASIC), and so on, the new designs and architectures still fail to meet the data processing demands because these architectures are not specifically designed for processing vast amounts of data. An alternative architecture to the control flow architectures is based on data flow. In a data flow architecture, the execution of instructions, functions, subroutines, etc., is based on the presence or absence of data. This latter approach, that of a data flow architecture, is better suited to handling the large amounts of unstructured data that are processed as part of the machine learning and deep learning applications.

Neural networks can be implemented using a reconfigurable fabric comprised of processing elements, switching elements, and/or memory elements. In order to train the nodes (neurons) of a neural network to “think,” training data can be applied to the neural network. The results, based on the training data from each layer of nodes, can then be propagated forward to achieve an end result. Error data can then be generated by comparing the neural network result of processing the training data to a desired result included with the training data. The error data can then be backward propagated into the network to fine tune the weightings of each layer. The training process can be iterated until desired results are achieved.

Tensor radix point calculation in a neural network is realized using a reconfigurable fabric. The reconfigurable fabric includes processing elements, switching elements, memory elements, communications capabilities, and so on. A computer-implemented method for computational manipulation is disclosed comprising: obtaining a first tensor; generating a first set of weights for the first tensor; evaluating an operation to be performed by a layer within a deep neural network on the first tensor using the first set of weights; determining a set of output radix points for the layer within the deep neural network based on the first tensor and the operation; calculating an output tensor for the layer within the deep neural network using the set of output radix points, the first tensor, and the first set of weights; and restarting the operation, when the layer reports a hardware overflow, using an updated set of output radix points. In embodiments, the determining is further based on a radix point for the first tensor. In embodiments, the determining is further based on metadata for the first tensor. In embodiments, the determining is further based on the first set of weights, and in some embodiments, the determining is further based on a radix point for the first set of weights.

In embodiments, the determining is further based on a preceding radix point for a preceding output tensor. In embodiments, the determining employs a fixed radix point for the operation to be performed when it has a fixed output range, and in some embodiments, the operation with a fixed output range includes one or more of a sine operation, a cosine operation, a hyperbolic tangent operation, a softmax operation, and a sigmoid operation. In embodiments, the determining employs a greater of function, a max of function, or a sum of function on radix points from the first tensor for the operation to be performed when it is a mathematically determinative operation, and in some embodiments, the mathematically determinative operation includes one or more of a max pooling operation, an average pooling operation, a drop out operation, a concatenation operation, a square root operation, and a rectified linear unit (ReLU) operation. In embodiments, the determining employs a minimum function on radix points from the first tensor for the operation to be performed when it is a min pooling operation. In embodiments, the determining employs running sample data through the layer and setting the radix point at least one digit greater than the sample data result for the operation to be performed when it is a mathematically non-determinative operation, and in some embodiments, the mathematically non-determinative operation includes one or more of an addition operation, a multiplication operation, a convolution operation, a batch norm operation, an exponential linear unit (ELU) operation, or a dense layer operation. In other embodiments, the determining transposes floating-point operation radix points and fixed-point operation radix points. And in yet other embodiments, the set of output radix points is updated by deep neural network training.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for tensor radix point determination in a neural network.

FIG. 2 is a flow diagram illustrating factors in radix point determination.

FIG. 3 shows an example layer.

FIG. 4 shows an example layer with two input tensors and weights.

FIG. 5 illustrates example layers with forward propagation and backward propagation.

FIG. 6A shows example fixed radix point representations.

FIG. 6B shows example variable radix point representations.

FIG. 7 illustrates an example first layer and an example second layer.

FIG. 8 shows a deep learning block diagram.

FIG. 9 illustrates a cluster for coarse-grained reconfigurable processing.

FIG. 10 shows a block diagram of a circular buffer.

FIG. 11 illustrates a circular buffer and processing elements.

FIG. 12 is a system diagram for tensor radix point calculation in a neural network.

### DETAILED DESCRIPTION

Techniques are disclosed for tensor radix point calculation in a neural network. A tensor is a convenient mathematical structure for use in many neural network applications. However, data can be stored using many different schemas, and the disclosed techniques are applicable to other data structures besides tensors, such as list structures and tree structures. Neural networks, such as deep neural networks, convolutional neural networks, and so on, are developed to handle highly complex data processing requirements such as those related to “big data”. The vast big data datasets overwhelm conventional, control-based computer designs including Von Neumann techniques. In addition to handling and storing the sheer volumes of data, the neural networks can handle data with very small values and very large values. The number representation scheme chosen is critical to handling the dynamic ranges of the data. The number representation must handle the large dynamic ranges, accuracy requirements, saturation hazards, and so on. Number representation schemes can include fixed-point representations and floating-point representations. The former is computationally simple and can handle accuracy requirements until the fixed-point values reach a saturation point or overflow. Saturation can occur when a number or a result of an operation cannot be represented by the number of digits available to the fixed-point number representation scheme. Floating-point techniques can handle large dynamic ranges of numbers, but can suffer loss of precision, due to the smaller number of bits of precision in the representation, including an inability to handle small numbers and large number concurrently in various operations. For example, adding a small number to a large number can leave the large number unchanged. In addition, manipulation of floating-point representations is more computationally intensive.

A reconfigurable fabric is used to implement the deep neural network. The reconfigurable fabric includes communications capabilities and configurable elements that can be assigned to various operations. The reconfigurable fabric can include elements that can be configured as processing elements, switching elements, or memory elements. Configuration and control of the reconfigurable fabric elements can be controlled by using rotating circular buffers. Instructions loaded into a circular buffer can configure the element associated with the circular buffer and can enable the element to operate on data, including very large quantities of data. The rotating circular buffers can be statically scheduled so that processing time is minimized as there is no need to reload instructions into the circular buffers. In addition to the use of the reconfigurable fabric for the processing of large datasets, a number representation scheme based on variable radix points and fixed-point representations can be used. The variable radix points can be used to handle a wide and dynamic range of data values, and the variable radix point, fixed-point number representation scheme can be used to both simplify computations and reduce data storage requirements.

Tensor manipulation is performed within a neural network. A first tensor is obtained. The tensor can be in input tensor, a tensor from a previous layer in a deep neural network, and so on. A first set of weights is obtained for the first tensor. The weights can be used for scaling, normalization, etc. An operation is evaluated to be performed by a layer within a deep neural network on the first tensor using the first set of weights. The operation can be a Boolean operation, a pooling operation, a multiplication, a convolution, a rectification, etc. A set of output radix points is determined for the layer within the deep neural network based on the first tensor. The output radix points can be calculated, estimated, predicted, refined, and so on. An output tensor is calculated for the layer within the deep neural network using the set of output radix points, the first tensor, and the first set of weights. The output tensor can be a multidimensional matrix. The multidimensional matrix can be a three-dimensional matrix, a four-dimensional matrix, etc.

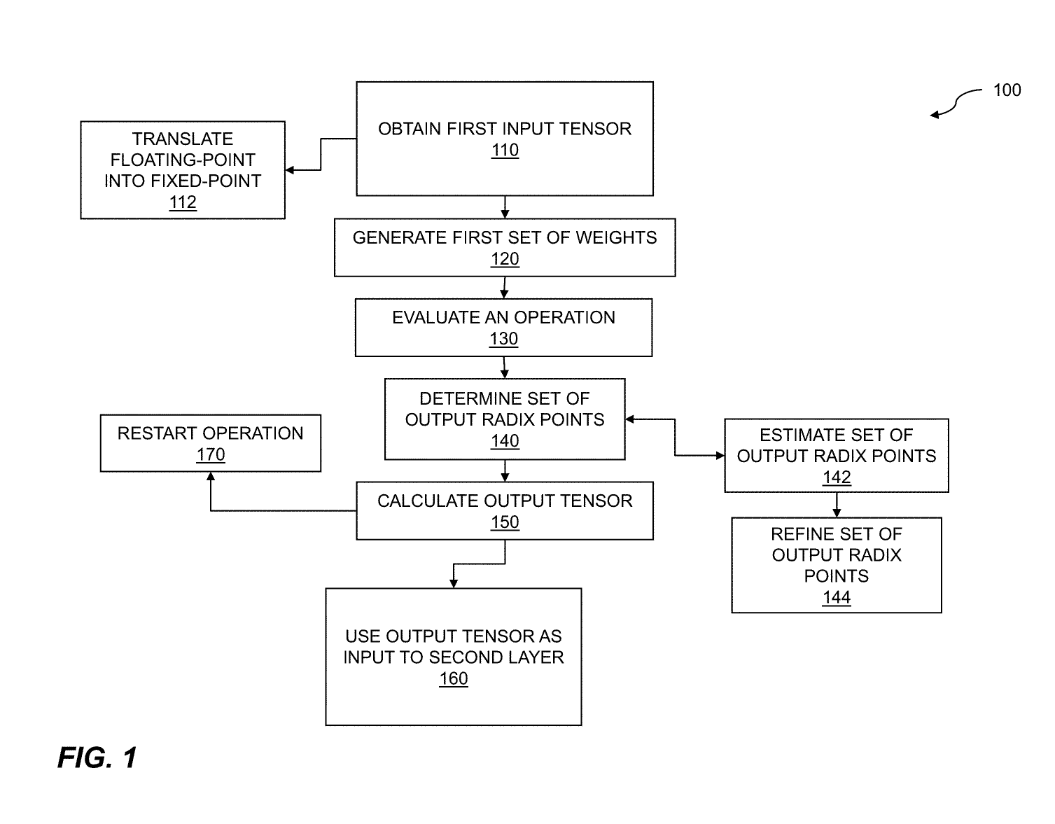

FIG. 1 is a flow diagram for tensor radix point determination in a neural network. The flow 100 includes obtaining a first tensor 110. The tensor can be loaded by a user, uploaded from a file, downloaded from library, and so on. The tensor can include integer values, real values, strings, vectors, arrays, matrices, and so on. In embodiments, the first tensor can be a multidimensional matrix. The multidimensional matrix can include one or more dimensions. In embodiments, the tensor is three-dimensional. In other embodiments, the tensor is four-dimensional. The tensor can include a plurality of arrays. The first tensor can include a fixed-point tensor, where the fixed-point tensor can include a fixed-point numerical representation. The fixed-point representations can be depicted in fixed radix point representations, a variable radix point representation, and so on. The flow 100 further includes translating a floating-point input tensor into fixed-point values 112 for use as the first tensor. The translating can be based on maximum values that can be represented by the fixed-point representation in the tensor, minimum values, dynamic range, and so on.

The flow 100 includes obtaining a first set of weights 120 for the first tensor. The weights can correspond to an amplitude of a connection between nodes within layers of a deep neural network. The set of weights can be a set of tensors. The first set of weights can be generated within the reconfigurable fabric or obtained from outside of the fabric. The weights can be generated based on machine learning. The machine learning can include training the weights, where the training is based on user training data. The flow 100 includes evaluating an operation 130 to be performed by a layer within a deep neural network on the first tensor using the first set of weights. The operation can include a tensor operation. The tensor operation can include tensor multiplication, convolution, max pooling, min pooling, ReLU (a rectified linear unit), and so on. Other operations can include tensor addition, Boolean operations, etc. In embodiments, the deep neural network is realized using a reconfigurable fabric. Reconfigurable fabrics can include arrays or clusters of elements. The elements can be clustered in quads. The reconfigurable fabric can be implemented as a custom integrated circuit or chip, a system on a chip (SoC), and so on. Reconfigurable fabrics can be applied to many applications where high-speed transferring and processing of data is performed. In embodiments, the reconfigurable fabric comprises processing elements, switching elements, or memory elements. The reconfigurable fabric can also include communications and interconnection capabilities. In embodiments, the elements can be controlled by rotating circular buffers. The rotating circular buffers can be loaded with instructions that can be used to control the processing elements. In embodiments, the rotating circular buffers can be statically scheduled. The static scheduling can include loading instructions into the circular buffers and controlling the circulation of the circular buffers. The circulation of the circular buffers allows execution of the instructions stored in the circular buffers.

The flow 100 includes determining a set of output radix points 140 for the layer within the deep neural network based on the first tensor. The set of output radix points can be based on including a radix point for the first tensor, including tensor metadata, weights, and so on. The tensor metadata can include tensor dimension, tensor element count, tensor radix points, tensor element precision, tensor element range, tensor element classification, etc. In embodiments, the determining of the set of output radix points includes estimating the set of output radix points 142 based on the first tensor. The estimating can be based on machine learning, where the machine learning is used to analyze the set of output radix points based on training, prediction, calculating, and so on. The set of output radix points can be refined. In embodiments, the flow 100 further includes refining the set of output radix points 144 for the layer within the deep neural network based on saturation or underflow occurrences. The refining can be based on machine learning. The refining can include forward propagation, backward propagation, and so on. The set of output radix points can be calculated. Details relating to calculating output radix points are described below. The set of output radix points is calculated based on a radix for the first tensor using a tensor multiplication operation by the layer. The calculating of the set of output radix points can be based on a layer operation, where the operation can include a tensor operation. The tensor operation can include multiplication. In embodiments, the set of output radix points can be calculated based on a radix for the first tensor using a tensor multiplication operation by the layer. When a second tensor is multiplied with the first tensor, the calculating can be further based on a radix point for a second tensor, where the operation is a tensor multiplication operation that multiplies the first tensor with the second tensor. Other tensor operations that can influence the calculation of the set of output radix points can be performed. In embodiments, the calculating is further based on a radix point for a second tensor, where the operation is a tensor convolution operation that multiplies the first tensor with the second tensor.

The set of output radix points 140 that is determined can be updated. In embodiments, the set of output radix points is updated by deep neural network training. The deep neural network training can include supervised training, unsupervised training, partially supervised training, and so on. Supervised training can include training the deep neural network using the first input tensor. In embodiments, the first tensor comprises deep neural network user training data. The user training data can be used to determine weights that can be associated with layers including hidden layers within the deep neural network. In embodiments, the deep neural network training includes forward propagation of the set of output radix points. The forward propagation can include updating weights, radix points, etc., in subsequent layers within the hidden layers of a deep neural network. In other embodiments, the deep neural network training includes backward propagation of error gradients for the set of output radix points. The backward propagation can include updating weights, amplitudes, scales, etc. The backward propagation can be used to minimize error as part of the training.

The flow 100 includes calculating an output tensor 150 for the layer within the deep neural network using the set of output radix points, the first tensor, and the first set of weights. The output tensor can include integer values, real values, strings, vectors, arrays, matrices, and so on. In embodiments, the first tensor can be a multidimensional matrix. The multidimensional matrix can include one or more dimensions. The tensor can be three-dimensional, four-dimensional, etc. As discussed below, the calculating of the output tensor can be based on a radix point for the first tensor, a radix point for a second tensor, a tensor multiplication, a tensor convolution, and so on. The calculating can be based on other tensor operations including rectification such as a rectified linear unit (ReLU), pooling such as max pooling or min pooling, addition, and so on. The flow 100 includes using the output tensor as an input to a second layer 160 within the deep neural network. The layers can be hidden within the deep neural network. When two or more layers are included in the deep neural network, the layer can be an input layer, a hidden layer, and so on. The second layer can be a hidden layer, an output layer, etc.

The flow 100 includes restarting the operation 170 when the layer hardware detects an overflow or underflow condition. Computer hardware is limited in the number of radix points of precision and the absolute magnitude of numerical representations. A simple example of an overflow condition can be seen by repeatedly squaring a number on a calculator. Even using scientific notation, the calculator will overflow after only a few squaring operations. Overflow or underflow conditions can be detected by computational hardware, such as a processing element of the reconfigurable fabric disclosed herein. Upon detection, the operation for the layer can be restarted with an updated radix point. The process can loop until a proper radix point is determined, that is, one which does not cause an overflow condition. In this way, computational efficiency and computational accuracy can be traded off. Many operations in a neural network can be accomplished much more efficiently by using a radix point that offers computational speed in return for sacrificing some degree of accuracy or precision. For example, training image recognition layers may require much less numerical accuracy and precision for pixel data than would be required for other operations. Of course, the restarting the operation 170 is only utilized when the determining algorithms described presently do not provide an adequate estimated set of output radix points 142.

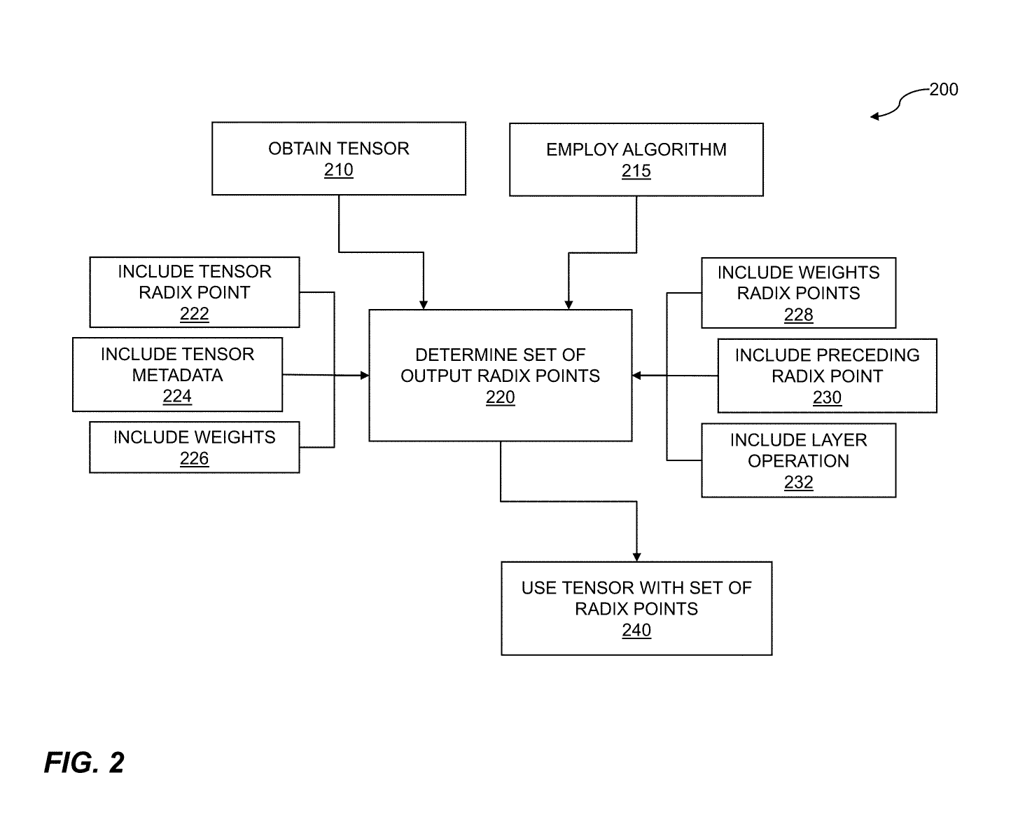

FIG. 2 is a flow diagram illustrating factors in radix point determination. Tensor radix point calculation is performed in a neural network. The neural network can include a deep neural network, a convolutional neural network, and so on. A first tensor is obtained. The first tensor can include a multidimensional matrix such as a three-dimensional matrix, a four-dimensional matrix, and so on. A first set of weights is generated for the first tensor. The first set of weights can include a tensor. An operation is evaluated that is to be performed by a layer within a deep neural network on the first tensor using the first set of weights. The operation can include various tensor operations, where the tensor operation can operate on multidimensional tensors. A set of output radix points is determined for the layer within the deep neural network based on the first tensor. The determining can be further based on a radix point and metadata for the first tensor, the first set of weights and a radix point for the first set of weights, a preceding radix point for a preceding output tensor, the operation to be performed by the layer, and so on. An output tensor is calculated for the layer within the deep neural network using the set of output radix points, the first tensor, and the first set of weights. The calculating can be based on a radix point for a first tensor, and can be further based on a radix point for a second tensor. The calculating can be based on an operation such as tensor multiplication, tensor convolution, etc.

The flow 200 includes obtaining a first tensor 210. A tensor can be a multidimensional array, where the multidimensional array can include a three-dimensional array, a four-dimensional array, and so on. The tensor can include input data, data from a prior layer such as a hidden layer, etc. The first tensor can include one or more fixed-point representations. The fixed-point representations can include fixed radix point representations, variable radix point representations, and so on. The flow 200 includes employing an algorithm 215 for the determining a set of output radix points 220. The algorithm can include several classes of operations that lead to several different algorithmic choices. For example, certain operations have fixed output ranges, so the algorithm can include setting the radix point based on the operation having a fixed output range. Fixed output range functions can include the sine function, which has a range of −1 to +1. Other fixed output range functions can include cosine, hyperbolic tangent (tan h), softmax, and sigmoid operations.

Another class of operations that can lead to a different algorithmic choice is the mathematically deterministic operations. For example, a max pool operation will have as its output value the maximum value contained in the pool of data being evaluated or operated on. Therefore, the algorithm can include setting the radix point based on a greater of function, a max of function, or a sum of function. Operations falling into this algorithmic category include max pool, average pool, drop out, concatenation, square root, and rectified linear unit (ReLU). Another class of operations that can lead to a different algorithmic choice is the mathematically non-deterministic class. Setting the radix point for this class of functions is based on running a small set of training data before the normal operational data is run. The operation is completed through a layer or many layers of the neural network, and the output is evaluated. The radix point for subsequent non-deterministic operations is then set to at least one radix point bigger than was required for the training data output result. Mathematically non-deterministic operations can include convolution (1D, 2D, or 3D convolution), batch normal, add, multiply, exponential linear units (ELU), and dense layer operations, especially those normally run with floating-point data representations. In embodiments, mathematically non-deterministic operations set the radix point to exactly one bit more than the training data provides. In other embodiments, mathematically non-deterministic operations set the radix point to exactly two bits more than the training data provides.

The flow 200 includes determining a set of output radix points 220 for the layer within the deep neural network based on the first tensor. The set of output radix points can include fixed radix points, variable radix points, and so on. The determining of the set of radix points can include calculating, estimating, refining, etc. The determining 220 can be further based on including a radix point for the first tensor 222. The radix point can be a fixed radix point, a variable radix point, and so on. The first tensor can be a multidimensional matrix. The determining 220 can be further based on metadata 224 for the first tensor. The metadata for the first tensor can include tensor dimension, tensor element count, tensor radix points, tensor element precision, tensor element range, tensor element classification, and the like. The determining 220 can be further based on the first set of weights 226. The set of weights can be generated for the first tensor, updated using backward propagation, updated using forward propagation, downloaded from a library, and so on.

The determining 220 can be further based on a radix point for the first set of weights 228. The radix point for the first set of weights can be duplicated as part of the determining. The radix point for the first set of weights can be calculated, predicted, and so on. In embodiments, the determining of the set of output radix points includes estimating based on the first tensor. The estimating can be based on machine learning. The determining can further include refining the set of output radix points for the layer within the deep neural network based on saturation or underflow occurrences. The refining can be based on minimizing error, maximizing dynamic range, etc. The determining 220 can be further based on a preceding radix point 230 for a preceding output tensor. The preceding output tensor can be the output tensor from the preceding layer such as a hidden layer. The preceding output tensor can be the immediately preceding layer, or another layer which is farther back in the hidden layers (e.g. forward propagation). The determining 220 can be further based on the operation 232 to be performed by the layer. The operation can be tensor multiplication, convolution, max pooling, min pooling, rectification such as ReLU, etc. In embodiments, the set of output radix points uses a maximum radix point from the first tensor for a max pooling operation by the layer. In other embodiments, the set of output radix points uses a minimum radix point from the first tensor for a min pooling operation by the layer. The flow 200 includes using the tensor with the set of radix points 240. Using the tensor can include performing a tensor operation by accessing a hidden layer in the deep neural network. The results of performing the tensor operation can include updating the set of radix points for use by a preceding layer (back annotation), updating the set of radix points for use by a subsequent layer (forward annotation), and so on.

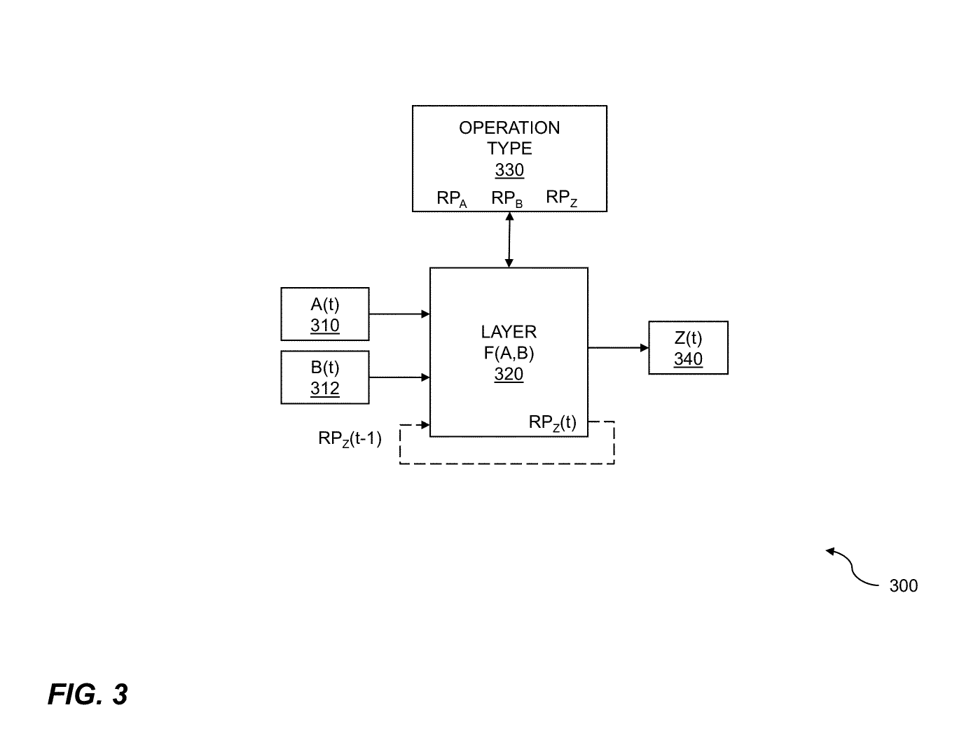

FIG. 3 shows an example layer. Layers such as input layers, output layers, hidden layers, and so on can be included in neural networks. Neural networks such as deep neural networks (DNN), convolutional neural networks (CNN), and so on, can be applied to deep learning and other techniques. The neural networks can manipulate data types including tensors. The layers can support tensor radix point calculation in a neural network. A first tensor is obtained, and a first set of weights is generated for the first tensor. An operation is evaluated to be performed by a layer within a deep neural network on the first tensor using the first set of weights. The operation can include various tensor operations such as tensor multiplication, convolution, max pooling, min pooling, or ReLU. A set of output radix points is determined for the layer within the deep neural network based on the first tensor. The determining can be further based on a radix point for the first tensor, metadata for the first tensor, the first set of weights, a radix point for the first set of weights, a preceding radix point for a preceding output tensor, the operation to be performed by the layer, and so on. An output tensor is calculated for the layer within the deep neural network using the set of output radix points, the first tensor, and the first set of weights. The calculating can be based on a radix point for a first tensor, and further based on a radix point for a second tensor. The calculating can be based on an operation such as tensor multiplication, tensor convolution, etc.

An example 300 can include layer F(A, B) 320. The layer 320 can include an input A(t) 310 and an input B(t) 312. The input A(t) 310 can include fixed-point values, variable radix point values, tensors, vectors, and so on. The input B(t) 312 can also include values such as weights. In embodiments, a first weighting tensor can have fixed-point values with a third set of variable radix points, where the third set of radix points can be associated with the fixed-point values of the first weighting tensor. The layer 320 can receive a set of radix points. In embodiments, a second set of variable radix points can be a function of a preceding set of variable radix points associated with the fixed-point values of a previous output tensor. The set of radix points can include radix points from another computation, such as radix points RPz(t−1). The layer 320 can include an operation type 330. The operation type 330 can include a convolution, a rectification such as a rectified linear unit (ReLU), pooling such as max pooling or min pooling, Boolean operations, addition, multiplication, and so on. The operation type can operate on values such as tensors. The tensors can include a set of variable radix points. The operation type 330 can include a set of variable radix points for input A(t), RPA, a set of variable radix points for input B(t), RPB, a set of variable radix points from another operation RPz, and the like. In embodiments, the first set of variable radix points has different radix points for different blocks within the first input tensor. The layer 320 can produce an output Z(t) 340. The output Z(t) can be a tensor with an associated set of variable radix points RPz(t). As discussed above, the associated set of variable radix points can be used by layer F(A, B) 320 or another layer for a similar operation or a different operation. In embodiments, the set of output radix points can be updated by deep neural network training. The deep neural network training can include machine learning.

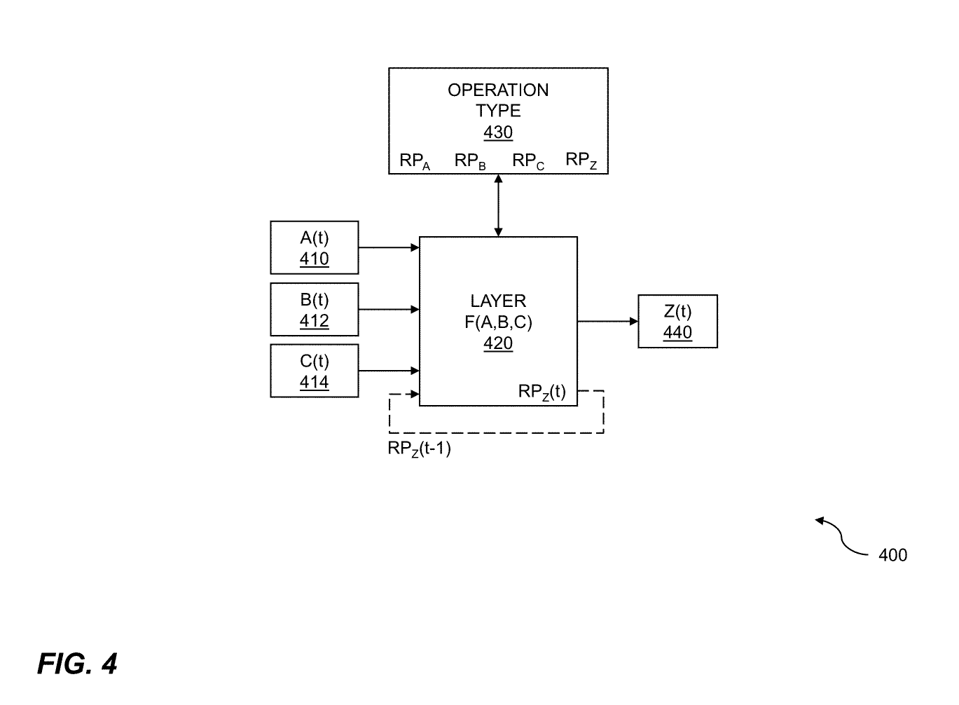

FIG. 4 shows an example layer with two input tensors and weights. Similar to the case of a layer with two inputs described above, layers with three inputs, such as input layers, output layers, hidden layers, and so on, can be included in neural networks. An example 400 can include layer F(A, B, C) 420. The layer 420 can include an input A(t) 410, an input B(t) 412, and an input C(t) 414. The input A(t) 410 can include fixed-point values, variable radix point values, tensors, vectors, and so on. The input B(t) 412 can also include fixed-point values, variable radix point values, tensors, vectors, and so on. The input C(t) 414 can include values similar to A(t) and B(t), and can further include values such as weights. In embodiments, a first weighting tensor, such as C(t) 414, can have fixed-point values with other sets of variable radix points, where the other sets of radix points can be associated with the fixed-point values of another input tensor, the first weighting tensor, and so on. The layer 420 can receive a set of radix points. In embodiments, a set of variable radix points can be a function of a preceding set of variable radix points associated with fixed-point values of a previous output tensor. The set of radix points can include radix points from another computation, such as radix points RPz(t−1). The layer 420 can include an operation type 430. The operation type 430 can include a convolution, a rectification such as by a rectified linear unit (ReLU), pooling such as max pooling and min pooling, Boolean operations, addition, multiplication, and so on. The operation type can operate on values such as tensors. The tensors can include a set of variable radix points. The operation type 430 can include a set of variable radix points for input A(t), RPA, a set of variable radix points for input B(t), RPB, a set of radix points for input C(t), RPc, a set of variable radix points from another operation RPz, and the like. In embodiments, the first set of variable radix points has different radix points for different blocks within the first input tensor. The layer 420 can produce an output Z(t) 440. The output Z(t) can be a tensor with an associated set of variable radix points RPz(t). As discussed above, the associated set of variable radix points can be used by layer F(A,B,C) 420 or another layer for another operation.

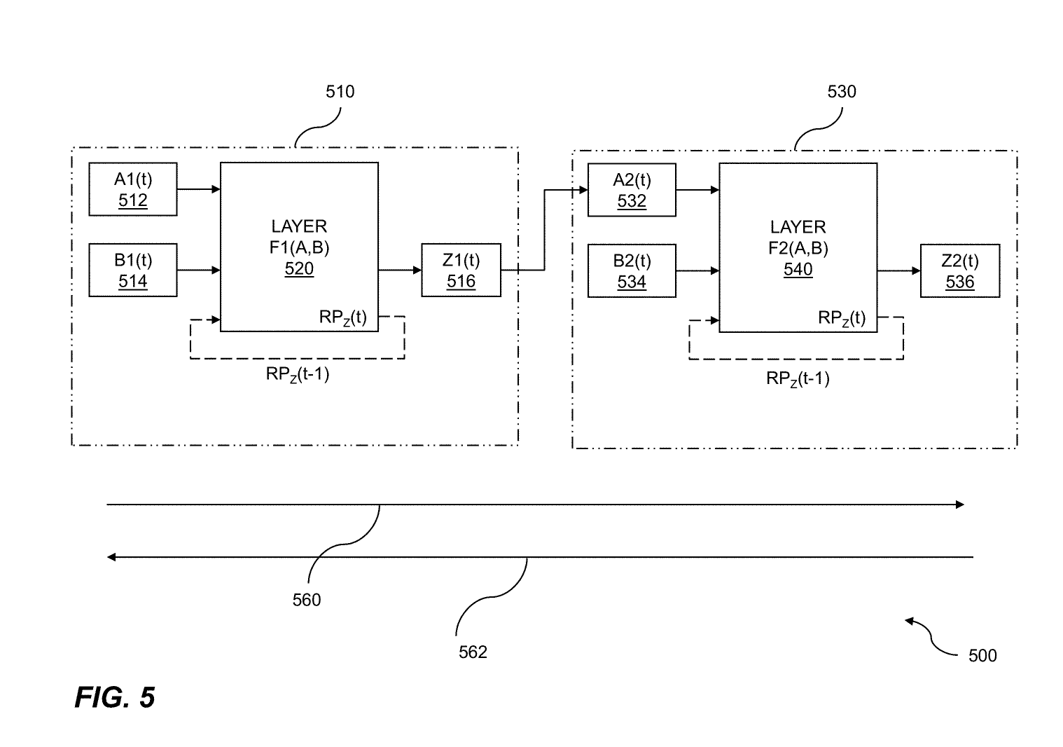

FIG. 5 illustrates example layers 500 with forward propagation and backward propagation. The layers can include an input layer, an output layer, a fully connected layer, hidden layers, and so on. Two layers 510, 530 are shown. The first layer 510 includes an input A1(t) 512 and an input B1(t) 514. Input A1(t) can be a tensor, a vector, fixed-point number, and so on. Input B1(t) can include weights, data, etc. The first layer shown 510 includes a layer operation F1(A,B) 520. The layer operation 520 can include a Boolean operation, a convolution, a rectified linear unit (ReLU), a pooling operation such as a max pooling operation, addition, multiplication, and so on. The layer operation 520 can determine an output Z1(t) 516. The layer operation 520 can determine a set of radix points such as RPz(t). The set of radix points can be fed back RPz(t−1) to the layer operation 520. A second layer depicted 530 includes an input A2(t) 532, and an input B2(t) 534. In embodiments, the first output tensor can be used as an input to a second layer within the deep neural network with a set of radix points for the input to the second layer. The input A2(t) 532 can include an output from another layer, such as Z1(t) 516 from the previous layer 510. The input B2(t) can include weights, etc. The second layer 530 includes a layer operation F2(A,B) 540. As with the first layer operation 520, the second layer operation 540 can also include a Boolean operation, a convolution, a ReLU, a pooling operation, an addition, a multiplication, etc. The layer operation in this second layer 540 can produce an output Z2(t) 536, a set of radix points RPz(t), etc. The set of radix points can be fed back RPz(t−1) to the second layer operation 540.

The layers shown 510, 530 can be layers in a deep neural network, a convolutional neural network, and so on. When the layers are included in a neural network for learning such as deep learning, weights used by a given layer can be updated as part of a learning technique. The learning technique can include training the neural network. The weights can include input B1(t) 514, input B2(t) 534, etc. The updating of the weights can be based on forward propagation 560, on backward propagation 562, on both forward propagation and backward propagation, and so on. For forward propagation 560, the updating of weights such as weights B2(t) 534 can be based on an output from a stage, such as Z1(t) 516. In embodiments, the deep neural network training includes forward propagation of the set of output radix points. The deep neural network training can include forward propagation of a set of weights. In embodiments, the deep neural network training includes backward propagation of error gradients for the set of output radix points. For backward propagation 562, the updating of weights such as weights B1(t) 514 can be based on an output from a stage, such as Z2(t) 536. In embodiments, the training includes backward propagation of error gradients, that is, values that are sent to prior layers to adjust the weights and make corrections to them for future use. The forward propagation 560 and the backward propagation 562 can be used to adjust tensors such as weighting tensors. In embodiments, the adjusting further includes adjusting the first weighting tensor based on the forward propagation and the backward propagation.

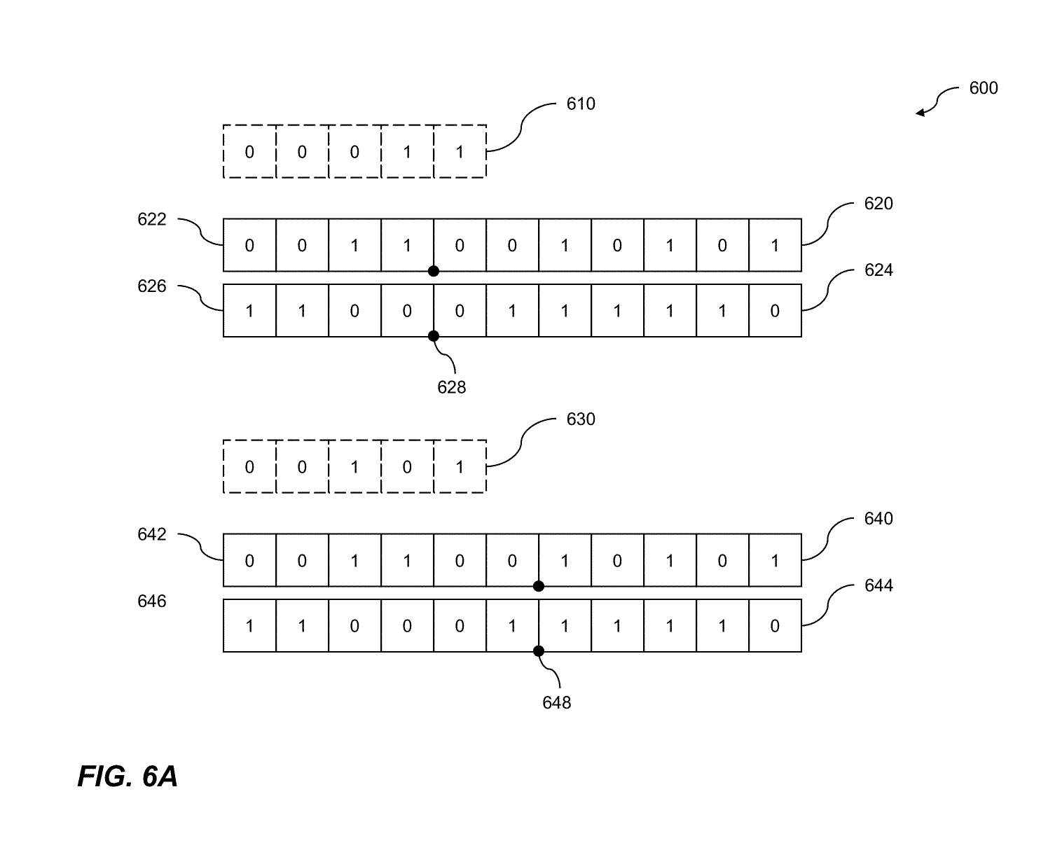

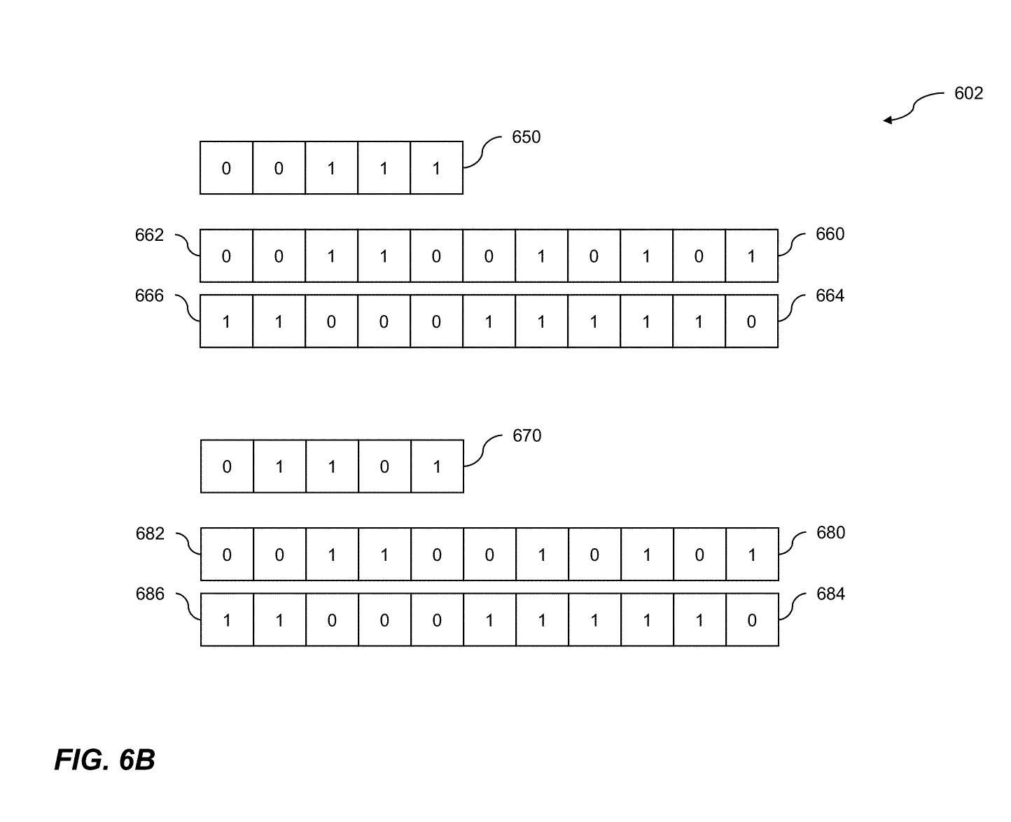

FIG. 6A shows example fixed radix point representations. Fixed radix point representations of numbers can represent tensors. The tensors can be manipulated within a neural network. The neural network, such as a deep neural network (DNN), convolutional neural network (CNN), and so on, can be used for deep learning and other techniques. Real data types can be represented by fixed-point representations, where the fixed-point representation can include a fixed or implied radix point, shown in example 600. For the fixed-point representation, there can be a specific number of digits to the left of the radix point, and a specific number of digits to the right of the radix point. The number of digits to the right or to the left of the radix point can be zero digits. The number of digits to the left of the radix point can be the integer portion of a number, and the number of digits to the right of the radix point can be the fractional portion of a number. The radix point can be a binary point, a decimal point, an octal point, a binary-coded decimal point, a hexadecimal point, and so on, depending on the numbering scheme chosen for a given task. A scaling factor, such as scaling factor 610 and scaling factor 630 can imply the location of the radix point. The implied scaling factor 610 implies that the radix point can be positioned with three integer digits to the left of the radix point. In addition, a sign bit can be the leftmost digit, as shown by digits 622, 626, 642, and 646. Similarly, the implied scaling factor 630 can imply that the radix point can be positioned with five digits to the left of the radix point. Other scaling factors can be used including zero digits to the left of the radix point, all digits to the left of the radix point, digits to the right of the radix point, and so on.

A group of bits 620 is shown with an implied radix point and a sign bit digit 622. The implied radix point can be determined by a scaling factor 610. The sign bit digit 622 can be a zero to indicate that the number represented by the group of bits 620 is a positive number. An analogous group of bits 624 is shown with the implied radix point indicated by a large dot 628. A sign bit digit 626 is again shown. The group of bits 624 can be equivalent to the group of bits 620, with the addition of the implied radix point explicitly shown by large dot 628. Again, the sign bit digit 626 can be a zero to indicate that the number represented by the group of bits 624 is a positive number. Positive numbers and negative numbers can be represented using techniques such as signed magnitude, ones' complement, twos' complement, and so on. In addition to leftmost digit sign bit digit 626, the group of bits 624 can have three integer digits to the left of the implied radix point, indicated by large dot 628 and implied by the scaling factor 610.

A group of bits 640 is shown with an implied radix point and a sign bit digit 642. The sign bit digit 642 can be a one to indicate that the number represented by group of bits 640 is negative. A previously stated, the radix point can be implied by scaling factor 630. Scaling factor 630 is the binary representation of a five, which implies there can be five integer digits to the left of the implied radix point. A group of bits 644, analogous to the group of bits 640, is shown with the implied radix point indicated by large dot 648. The implied radix point large dot 648 can be determined by the scaling factor 630. Thus, the group of bits 644 has a left most digit for sign bit digit 646 and then five integer digits to the left of the implied radix point large dot. In example 600, the sign bit digit 646 of the group of bits 644 can be a one, which can indicate that the number represented is a negative number.

FIG. 6B shows example variable radix point representations. The variable radix representations 602 can be used for real data types, integer data types, and so on. The values represented by the variable radix representations can be scaled for accuracy, normalization, and other operations. A number 660 can have a sign bit digit 662. A number 664 can have a sign bit digit 666. A sign bit digit with a value of zero can indicate a positive number. A sign bit digit with a value of one can indicate a negative number. The numbers 660 and 664 can include a radix point (not shown). The scaling factor 650 can be used to scale numbers such as numbers 660 and 664 based on powers of a radix. For example, if numbers represented by digits of numbers such as numbers 660 and 664 are radix two numbers, then the scaling factor will be by powers of two. The value represented by scaling factor 650 is 2²+2¹+2⁰=4+2+1=7. Seven is used as the exponent for the radix of the scaling factor. The numbers 660 and 664 are scaled by 2⁷, where the scaling technique can include shifting left seven positions. The scaling factors can include a sign bit. A positive sign bit can indicate scaling by shifting left, and a negative sign bit can indicate scaling by shifting right.

Two other numbers, number 680 and number 684, are shown with a scaling factor 670. The number 680 can have a sign bit 682, and the number 684 can have a sign bit 686. As discussed above, a sign bit with a value of zero can indicate that the number with which the sign bit is associated is a positive number, and a sign bit with a value of one can indicate that the number with which the sign bit is associated is a negative number. The scaling factor 670 can be calculated as 2³+2²+0+2⁰=8+4+0+1=13. Thirteen is used as the exponent for the radix of the scaling factor 670. The number 680 and the number 684 are scaled by 2¹³, where the scaling technique can include shifting left number 680 and number 684 by thirteen positions.

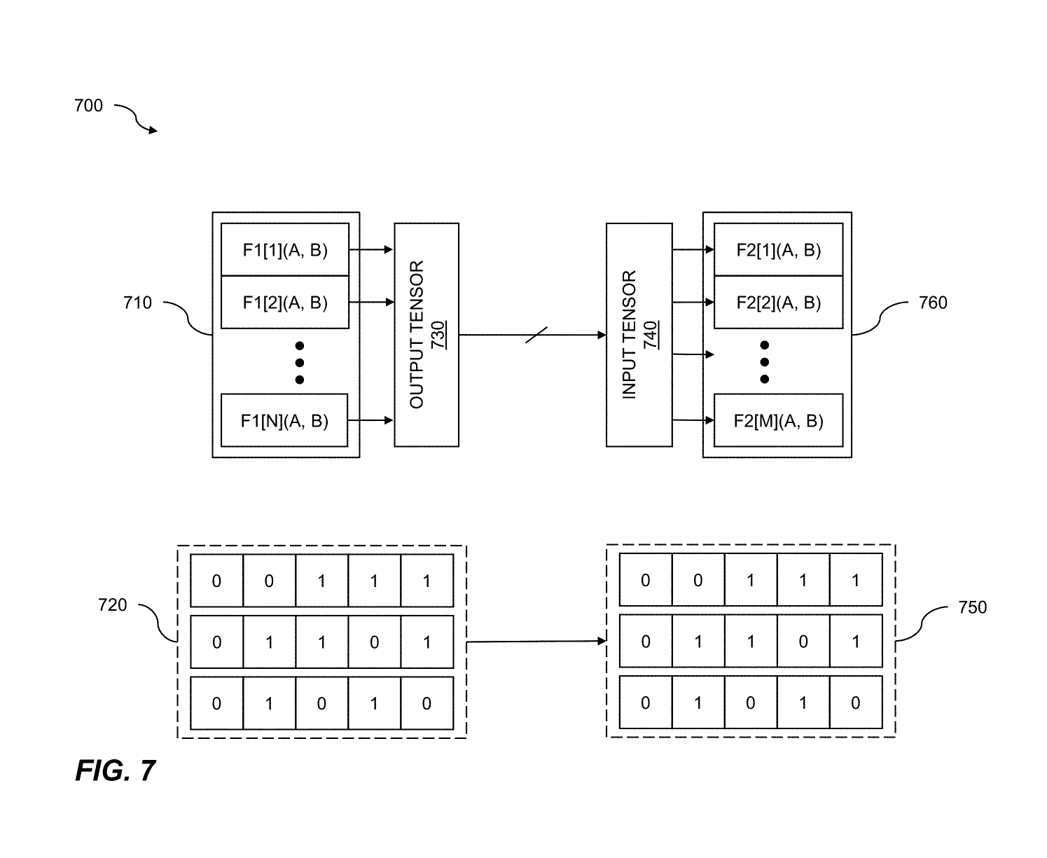

FIG. 7 illustrates an example first layer and an example second layer. The first layer and the second layer 700 can be layers of a neural network. A first input tensor is obtained for manipulation within a deep neural network, where the first input tensor includes fixed-point numerical representations, and where the first input tensor includes tensor metadata. The tensor metadata for each tensor can include tensor dimension, tensor element count, tensor radix points, tensor element precision, tensor element range, or tensor element classification. The first input tensor is applied to a first layer within the deep neural network, where the first input tensor with fixed-point values has a first set of variable radix points, and where the first set of variable radix points is associated with the fixed-point values of the first input tensor. A first weighting tensor is determined for the first input tensor applied to the first layer, where the first weighting tensor includes tensor metadata. A first output tensor is calculated from the first layer within the deep neural network based on the first input tensor and the first weighting tensor, where the first output tensor has fixed-point values with a second set of variable radix points, where the second set of variable radix points is associated with the fixed-point values of the first output tensor, and where the first output tensor includes tensor metadata.

The layers 700 of a deep neural network can include an input layer, an output layer, hidden layers, and so on. A first layer 710 can perform an operation. The operation, such as operation F1(A,B), can include one or more nodes such as nodes F1[1](A,B), F1[2](A,B), up to F1[N](A,B). The operations can include Boolean operations, mathematical operations, neural network operations, etc. The operations can include convolution, rectification with a rectified linear unit (ReLU), pooling such as max pooling, addition, multiplication, and the like. The values of the results of the operations performed by the first layer 710 can include variable radix points 720. The quantity of variable radix points 720 can be based on the range of values operated upon by first layer operation 710. In embodiments, each set of radix points can be determined per tensor. The set of radix points associated with a tensor can be included as input to a second layer or another layer. In embodiments, each set of variable radix points determined per tensor also can be determined per tensor dimension. The first layer can compute an output tensor 730. The output tensor can be stored with a register or other storage technique. The output tensor 730 can be coupled to a register or other storage technique used for holding an input tensor 740 to a second layer 760. The input tensor can include values that can include variable radix points 750. The quantity of variable radix points 750 can be dependent on the range of values to be operated upon by operation 760. A second layer can perform an operation. The operation, such as operation F2(A,B), can include one or more nodes such as nodes F2[1](A,B), F2[2](A,B), up to F2[M](A,B). As with the operation of the first layer, the operation of the second layer can include Boolean operations, mathematical operations, neural network operations, etc. The operations can include convolution, rectification with a rectified linear unit (ReLU), pooling such as max pooling, addition, multiplication, and so on.

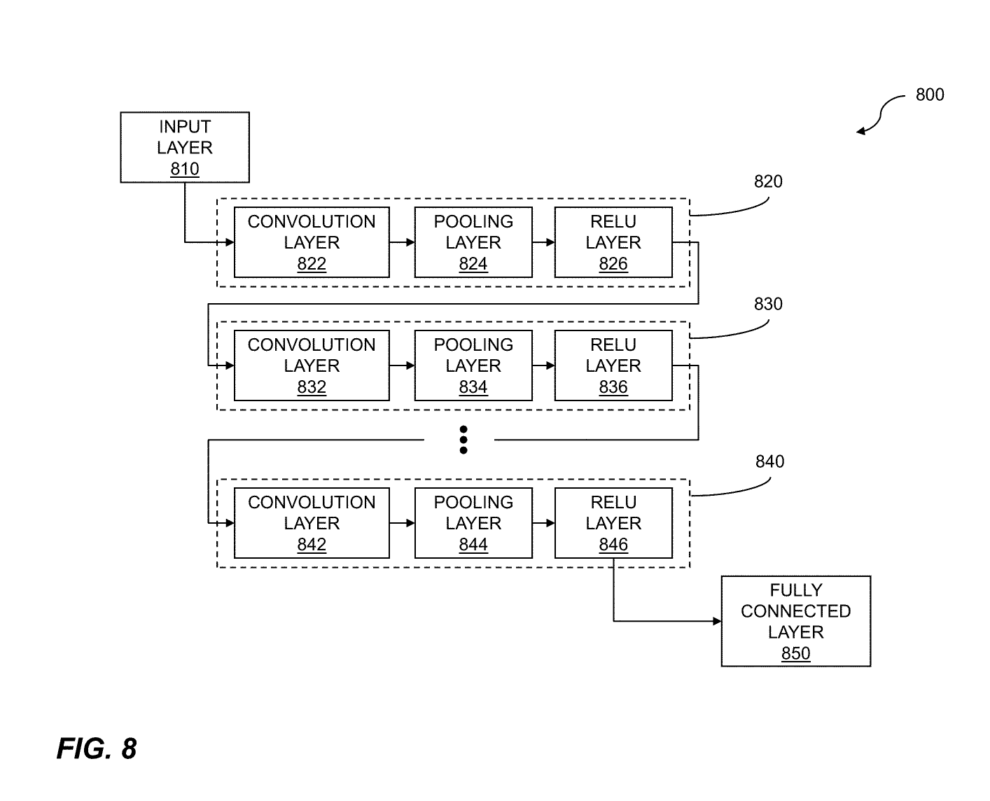

FIG. 8 shows a deep learning block diagram 800. Deep learning can be based on convolutional neural networks, where the convolutional neural networks can be organized in layers or other more general graph structures. The block diagram can include various layers, where the layers can include an input layer, hidden layers, a fully connected layer, and so on. In some embodiments, the deep learning block diagram can include a classification layer. The input layer 810 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning the collected data into non-overlapping partitions. The deep learning block diagram 800, which can represent a network such as a convolutional neural network, can contain a plurality of hidden layers. While three hidden layers 820, 830, 840, are shown, other numbers of hidden layers may be present. Each hidden layer can include layers that perform various operations, where the various layers can include a convolution layer, a pooling layer, and a rectifier layer such as a rectified linear unit (ReLU) layer. Thus, this first layer 820 can include a convolution layer 822, a pooling layer 824, and a ReLU layer 826; the second layer 830 can include a convolution layer 832, a pooling layer 834, and a ReLU layer 836; and the third layer 840 can include a convolution layer 842, a pooling layer 844, and a ReLU layer 846. The convolution layers 822, 832, and 842 can perform convolution operations; the pooling layers 824, 834, and 844 can perform pooling operations, including max pooling, such as data down-sampling; and the ReLU layers 826, 836, and 846 can perform rectification operations. A convolutional layer can reduce the amount of data feeding into a fully connected layer. The block diagram 800 can include a fully connected layer 850. The fully connected layer can be connected to each data point from the one or more convolutional layers. The final operation in a sequence of closely related operations is designated the activation. A ReLU layer can provide the activation of the previous operation among the layers. Other common activations include sigmoid, tan h, and softmax, to name just a few. Often, the activation layer is merged with the preceding operation into a single layer. This practice is especially common in inference functions within a neural network.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs organized in arrangements such as quads and can be coupled to arithmetic units, where the arithmetic units can be coupled to or included in data processing units (DPU). The DPUs can be shared between and among quads. The DPUs can provide arithmetic techniques to the PEs, communications among quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of −1 plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. The configuration mode for a cluster can include propagating a signal. Clusters can be preprogrammed to enter configuration mode. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by a data flow processor can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code to be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

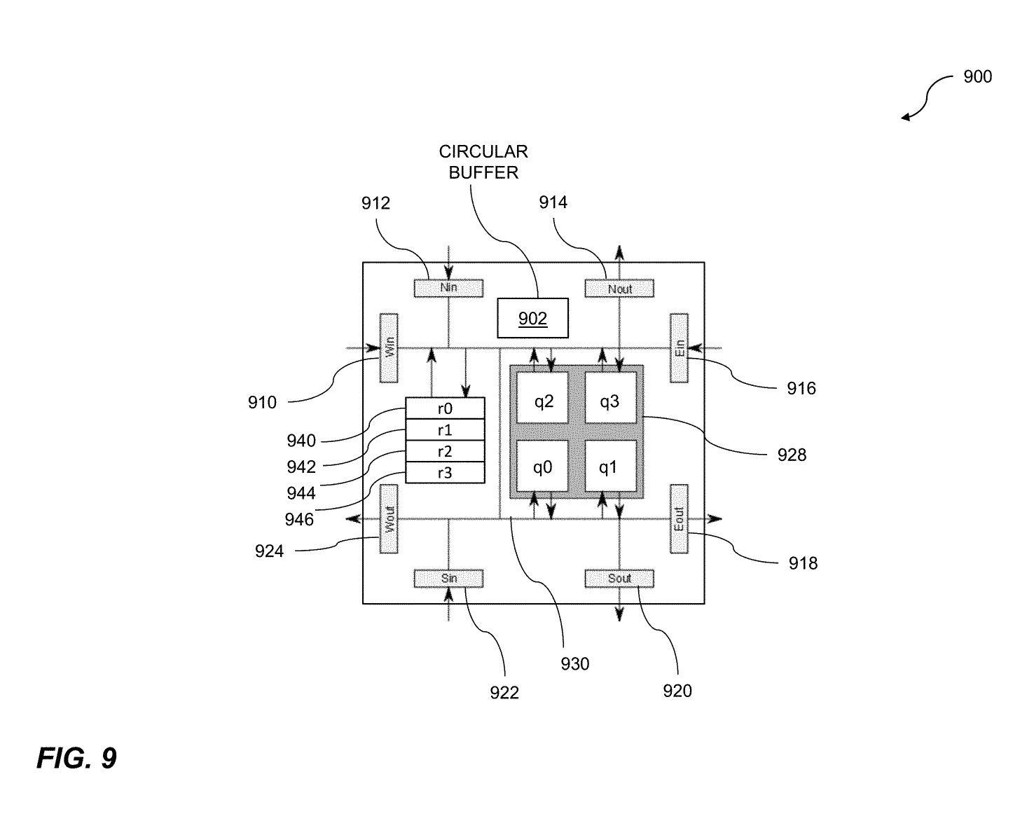

FIG. 9 illustrates a cluster for coarse-grained reconfigurable processing. The cluster for coarse-grained reconfigurable processing 900 can be used for tensor radix point calculation in a neural network. Data can be obtained from a first switching unit, where the first switching unit can be controlled by a first circular buffer. Data can be sent to a second switching element, where the second switching element can be controlled by a second circular buffer. The obtaining of data from the first switching element and the sending of data to the second switching element can include a direct memory access (DMA). The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements—q0, q1, q2, and q3. The four processing elements can be collectively referred to as a “quad,” and can be jointly indicated by a gray reference box 928. In embodiments, there is intercommunication among and between each of the four processing elements. In embodiments, the circular buffer 902 controls the passing of data to the quad of processing elements 928 through switching elements. In embodiments, the four processing elements 928 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements: r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than to store the data in a register first, and then send the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can execute any safe function of the two inputs. For example, the fan-in could implement a logical OR of the input data. Any output data is acceptable because the input condition is an error, so long as no damage is done to the silicon. In the event that a bit is set to ‘ I’ for both inputs, an output bit should also be set to I′. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs and registers that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing shared access to them by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

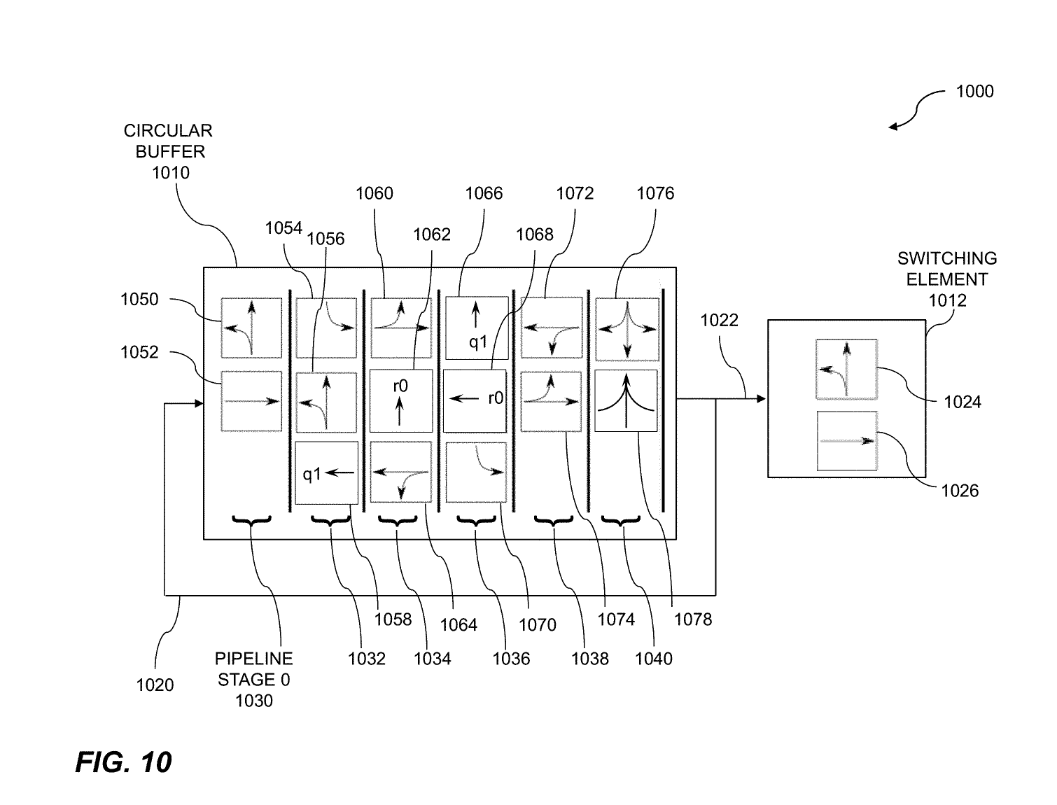

FIG. 10 shows a block diagram of a circular buffer. The circular buffer 1000 can include a switching element 1012 corresponding to the circular buffer. The switching element 1012 and the circular buffer 1010 can be used in part for tensor radix point calculation in a neural network. Returning to the FIG. 1000, for circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining of data from the first switching element and the sending of data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the example 1000 shown, Pipeline Stage 0 1030 has an instruction depth of two instructions 1050 and 1052. Though the remaining pipeline stages 1-5 are not textually labeled in the FIG. 1000, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3 which were referenced in FIG. 9. The registers are, in embodiments, storage elements which store data while the configurable connections are busy with other data. In embodiments, the storage elements are 32-bit registers. In other embodiments, the storage elements are 64-bit registers. Other register widths are possible.

The obtaining of data from a first switching element and the sending of the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself in a sleep state. When the DMA transfer terminates, the processing elements and/or switching elements in the cluster can be brought out of sleep state after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. The switching element 1012 contains instructions 1024 and 1026 which can be transferred back to pipeline stage 0 as new instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. In contrast, not skipping an operation indicates that a valid instruction is being given in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction can be explicitly specified that causes no execution to be performed until a predetermined event occurs which causes the logical element to exit the sleep state. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus which is external to and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operate on the received data. In the event that the data is not valid, the processor q1 can remain in a sleep state. At a later time, data can be retrieved from the q1 processor by using an instruction 1066. In the case of this instruction 1066, data from the processor q1 is moved to the north output. In some embodiments, if Xs have been placed into the processor q1, such as during the instruction 1058, then Xs would be retrieved from the processor q1 during the execution of a new instruction 1066 and applied to the north output of the new instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use preprocessing, such as by a compiler, to arrange the instructions in such a way that there are no collisions when the instructions are loaded into the circular buffer. Thus, the circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions 1062, sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to zero and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

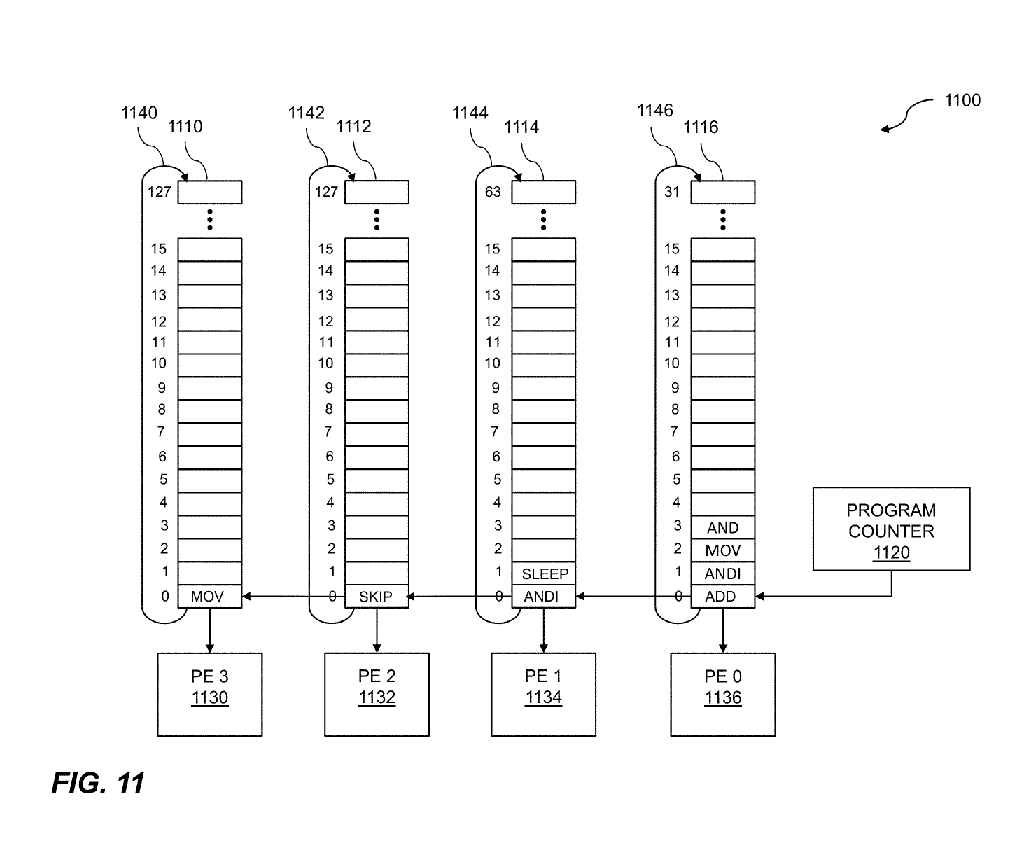

FIG. 11 illustrates a circular buffer and processing elements. The figure shows a diagram 1100 indicating example instruction execution for processing elements. The instruction execution can include instructions for tensor radix point calculation in a neural network. A circular buffer 1110 feeds a processing element 1130. A second circular buffer 1112 feeds another processing element 1132. A third circular buffer 1114 feeds another processing element 1134. A fourth circular buffer 1116 feeds another processing element 1136. These circular buffers are shown with lengths of 128 entries but various lengths are possible. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1110 and 1112 have a length of 128 instructions, the circular buffer 1114 has a length of 64 instructions, and the circular buffer 1116 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, the first circular buffer 1110 contains a MOV instruction. The second circular buffer 1112 contains a SKIP instruction. The third circular buffer 1114 contains a SLEEP instruction and an ANDI instruction. The fourth circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

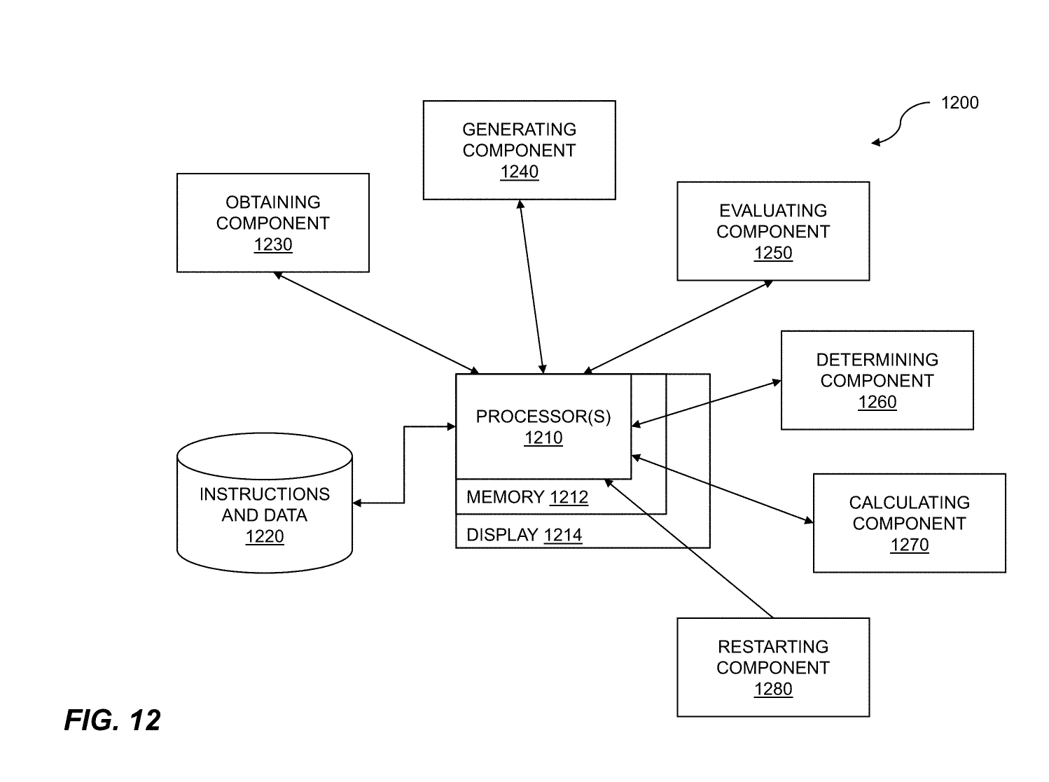

FIG. 12 is a system diagram for tensor radix point calculation in a neural network. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 are attached to the memory 1212 where the one or more processors, when executing the instructions which are stored, are configured to: obtain a first tensor; generate a first set of weights for the first tensor; evaluate an operation to be performed by a layer within a deep neural network on the first tensor using the first set of weights; determine a set of output radix points for the layer within the deep neural network based on the first tensor and the operation; calculate an output tensor for the layer within the deep neural network using the set of output radix points, the first tensor, and the first set of weights; and restart the operation, when the layer reports a hardware overflow, using an updated set of output radix points.

The system 1200 can include a collection of instructions and data 1220. The instructions and data 1220 may be stored in a database, one or more statically linked libraries, one or more dynamically linked libraries, precompiled headers, source code, flow graphs, kernels, or other suitable formats. The instructions can include instructions for tensor radix point calculation in a neural network. The instructions can include metadata that is determined for each tensor. The tensor metadata for each tensor can include tensor dimension, tensor element count, tensor radix points, tensor element precision, tensor element range, or tensor element classification. The system 1200 can include an obtaining component 1230. The obtaining component 1230 can include functions and instructions for obtaining a first input tensor for manipulation within a deep neural network. The first input tensor can include fixed-point numerical representations and can include tensor metadata. The system 1200 can include a generating component 1240. The generating component 1240 can include functions and instructions for generating a first set of weights for the first tensor. The weights can include fixed-point values. The weights can be based on tensor metadata.

The system 1200 can include an evaluating component 1250. The evaluating component 1250 can include functions and instructions for evaluating an operation to be performed by a layer within a deep neural network on the first tensor using the first set of weights. The evaluating can be based on fixed radix point representations, variable radix point representations, and so on. The system 1200 can include a determining component 1260. The determining component 1260 can include functions and instructions for determining a set of output radix points for the layer within the deep neural network based on the first tensor. The determining can be based on a variety of values, factors, and parameters, such as a radix point for the first tensor, metadata for the first tensor, the first set of weights, a radix point for the first set of weights, and so on. The system 1200 can include a calculating component 1270. The calculating component 1270 can include functions and instructions for calculating an output tensor for the layer within the deep neural network using the set of output radix points, the first tensor, and the first set of weights. In embodiments, the set of output radix points can be calculated based on a radix for the first tensor for a tensor multiplication operation by the layer. The calculating can be further based on a radix point for a second tensor, where the operation is a tensor multiplication operation that multiplies the first tensor with the second tensor. The second tensor can include a second set of radix points. In embodiments, the calculating can be further based on a radix point for a second tensor, where the operation is a tensor convolution operation that multiplies the first tensor with the second tensor.

The system 1200 can include a restarting component 1280 for when layer hardware detects an overflow or underflow condition. Computer hardware is limited in the number of radix points of precision and the absolute magnitude of numerical representations. A simple example of an overflow condition can be seen by repeatedly squaring a number on a calculator. Even using scientific notation, the calculator will overflow after only a few squaring operations. Overflow or underflow conditions can be detected by computational hardware, such as a processing element of the reconfigurable fabric disclosed herein. Upon detection, the operation for the layer can be restarted with an updated radix point. The process can loop until a proper radix point is determined, that is, one which does not cause an overflow (or underflow) condition. In this way, computational efficiency and computational accuracy can be traded off. Many operations in a neural network can be accomplished much more efficiently by using a radix point that offers computational speed in return for sacrificing some degree of accuracy or precision. For example, training image recognition layers may require much less numerical accuracy and precision for pixel data than would be required for other operations. Of course, the restarting component 1280 is only utilized when the determining component 1260 does not provide an adequate estimated set of output radix points.

The system 1200 can include a computer program product embodied in a non-transitory computer readable medium for computational manipulation, the computer program product comprising code which causes one or more processors to perform operations of: obtaining a first tensor; generating a first set of weights for the first tensor; evaluating an operation to be performed by a layer within a deep neural network on the first tensor using the first set of weights; determining a set of output radix points for the layer within the deep neural network based on the first tensor and the operation; calculating an output tensor for the layer within the deep neural network using the set of output radix points, the first tensor, and the first set of weights; and restarting the operation, when the layer reports a hardware overflow, using an updated set of output radix points.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special-purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for computational manipulation comprising:
obtaining a first tensor;
generating a first set of weights for the first tensor;
evaluating an operation to be performed by a layer within a deep neural network on the first tensor using the first set of weights;
determining a set of output radix points for the layer within the deep neural network based on the first tensor and the operation;
calculating an output tensor for the layer within the deep neural network using the set of output radix points, the first tensor, and the first set of weights; and
restarting the operation, when the layer reports a hardware overflow, using an updated set of output radix points.

2. The method of claim 1 wherein the determining is further based on a radix point for the first tensor.

3. The method of claim 1 wherein the determining is further based on metadata for the first tensor.

4. The method of claim 1 wherein the determining is further based on the first set of weights.

5. The method of claim 4 wherein the determining is further based on a radix point for the first set of weights.

6. The method of claim 1 wherein the determining is further based on a preceding radix point for a preceding output tensor.

7. The method of claim 1 wherein the determining employs a fixed radix point for the operation to be performed when it has a fixed output range.

8. The method of claim 7 wherein the operation with a fixed output range includes one or more of a sine operation, a cosine operation, a hyperbolic tangent operation, a softmax operation, and a sigmoid operation.

9. The method of claim 1 wherein the determining employs a greater of function, a max of function, or a sum of function on radix points from the first tensor for the operation to be performed when it is a mathematically determinative operation.

10. The method of claim 9 wherein the mathematically determinative operation includes one or more of a max pooling operation, an average pooling operation, a drop out operation, a concatenation operation, a square root operation, and a rectified linear unit (ReLU) operation.

11. The method of claim 1 wherein the determining employs a minimum function on radix points from the first tensor for the operation to be performed when it is a min pooling operation.

12. The method of claim 1 wherein the determining employs running sample data through the layer and setting the radix point at least one digit greater than the sample data result for the operation to be performed when it is a mathematically non-determinative operation.

13. The method of claim 12 wherein the mathematically non-determinative operation includes one or more of an addition operation, a multiplication operation, a convolution operation, a batch norm operation, an exponential linear unit (ELU) operation, or a dense layer operation.

14. The method of claim 1 wherein the determining transposes floating-point operation radix points and fixed-point operation radix points.

15. The method of claim 1 wherein the set of output radix points is updated by deep neural network training.

16. The method of claim 15 wherein the deep neural network training includes forward propagation of the set of output radix points.

17. The method of claim 15 wherein the deep neural network training includes backward propagation of error gradients for the set of output radix points.

18-19. (canceled)

20. The method of claim 1 wherein the first tensor includes a fixed-point tensor.

21. The method of claim 20 further comprising translating a floating-point input tensor into fixed-point values for use as the first tensor.

22. The method of claim 1 wherein the first tensor is a multidimensional matrix.

23-24. (canceled)

25. The method of claim 1 wherein the first tensor comprises deep neural network user training data.

26-30. (canceled)

31. A computer program product embodied in a non-transitory computer readable medium for computational manipulation, the computer program product comprising code which causes one or more processors to perform operations of:
obtaining a first tensor;
generating a first set of weights for the first tensor;
evaluating an operation to be performed by a layer within a deep neural network on the first tensor using the first set of weights;
determining a set of output radix points for the layer within the deep neural network based on the first tensor and the operation;
calculating an output tensor for the layer within the deep neural network using the set of output radix points, the first tensor, and the first set of weights; and
restarting the operation, when the layer reports a hardware overflow, using an updated set of output radix points.

32. A computer system for computational manipulation comprising:
a memory which stores instructions;
one or more processors attached to the memory wherein the one or more processors, when executing the instructions which are stored, are configured to:
obtain a first tensor;
generate a first set of weights for the first tensor;
evaluate an operation to be performed by a layer within a deep neural network on the first tensor using the first set of weights;
determine a set of output radix points for the layer within the deep neural network based on the first tensor and the operation;
calculate an output tensor for the layer within the deep neural network using the set of output radix points, the first tensor, and the first set of weights; and
restart the operation, when the layer reports a hardware overflow, using an updated set of output radix points.
